(19) United States
(12) Patent Application Publication
(10) Pub. No.: US 2020/0311614 A1
(43) Pub. Date: Oct. 1, 2020

(54) Dropout for Ensemble Machine Learning Classifiers

(71) Applicant: PayPal, Inc., San Jose, CA (US)

(72) Inventors: Lichao Liu, Sunnyvale, CA (US); Zhanghao Hu, San Jose, CA (US)

(21) Appl. No.: 16/370,553

(22) Filed: Mar. 29, 2019

(51) Int. Cl. G06N 20/20; G06Q 20/40

(52) U.S. Cl. CPC G06N 20/20; G06Q 20/4016

(57) ABSTRACT

Machine learning often uses ensemble classifiers, such as random forest or gradient boosting tree classifiers to solve problems. One issue with such classifiers is that they may be prone to data overfitting. This can cause the classifier to perform relatively worse when dealing with data outside of a training set. One technique to avoiding overfitting is using random dropout on decision trees in the ensemble classifier (e.g. drop three percent of all decision trees to create a final classifier). However, random dropout can be improved upon. Penalty based dropout can assess the performance of individual trees using a validation data set (which may be separate from the training set). Instead of using random dropout, some of the worst performing trees can be dropped instead, leading to better overall performance.

### TECHNICAL FIELD

This disclosure relates to machine learning and artificial intelligence, and more particularly, to improving the performance of machine learning classifiers as related to ensemble classifiers including random forest and gradient boosting trees.

### BACKGROUND

Machine learning may help to automatically classify data, such as determining whether a particular data item is believed to fall into one category or another.

A set of known data can be used to train a classifier, which can then be used to operate on unknown data. For example, using training data that includes thousands of different pictures of cats and thousands of pictures of other items, a classifier could be trained to automatically recognize what a cat looks like. Even if the classifier has never seen a picture of some particular cat before, if it has seen enough pictures of similar-looking cats it can automatically recognize an “unknown” cat with some degree of confidence. Machine learning has many different applications depending on the underlying data, however, and can be used in many different contexts.

Further, different techniques can be used in solving machine learning problems. Some types of solutions use ensemble methods. Tree-based classifiers are one type of ensemble method, and can include random forest and gradient boosting trees.

These tree-based classifiers (as well as other types of classifiers) do not always perform optimally when they are used in a real-world environment. Applicant recognizes that there is a need to produce better performing machine learning solutions, and describes techniques below that can produce improved results, particularly for ensemble classifiers.

### BRIEF DESCRIPTION OF THE DRAWINGS

FIG. 1 illustrates a block diagram of a system that includes users devices, a machine learning system, a transaction system, a network, and a database according to some embodiments.

FIG. 2 illustrates a block diagram of a set of data records, according to some embodiments.

FIG. 3 illustrates a block diagram of an example individual decision tree 300 relating to ensemble machine learning techniques, according to some embodiments.

FIG. 4 illustrates a block diagram of a table relating to evaluating performance of particular decision trees within a machine learning classifier, according to some embodiments.

FIG. 5 illustrates a block diagram of another table relating to evaluating performance of particular decision trees within a machine learning classifier, according to some embodiments.

FIG. 6 illustrates a flowchart of a method relating to creating an improved machine learning classifier by evaluating individual decision trees in an ensemble classifier, according to some embodiments.

FIG. 7 is a diagram of a computer readable medium, according to some embodiments.

FIG. 8 is a block diagram of a system, according to some embodiments.

### DETAILED DESCRIPTION

Ensemble classifiers such as those using random forest or gradient boosting trees will frequently use a large number of decision trees and then combine results of the trees to produce an outcome.

In the case of assessing whether an electronic payment transaction represents a fraud risk, for example, hundred, thousands, or some other number of decision trees may each make their own prediction. Collectively, these predictions can then be used to determine whether that transaction should be allowed, or if the transaction represents a high enough fraud risk that it should not be allowed. A high fraud score can also indicate that a user should be required to perform an additional action, e.g., use two-factor authentication, contact a customer support representative to provide additional documentation, etc.

Each of the decision trees in an ensemble classifier may look at all or a subset of available data in order to make a classification for an item. In the case of an electronic payment transaction, available data can include a number of things-IP address of device making the transaction, country/region (location) of the device, amount of the transaction, email addresses of the payee and payor, technical details about the device itself (e.g. Samsung Galaxy™ S9 smartphone with 64 GB memory), type of good or service being purchased (e.g. jewelry, electronics, books, etc.), destination shipping address, buyer home address, etc. Many additional types of data may be available as well. An individual decision tree may look at all or a subset of these data and then make a prediction as to whether the transaction represents a fraud risk.

In order to train a classifier (which can include many decision trees that collectively make a prediction), sample training data may be used. For example, many (e.g. thousands or millions) of old transactions that are known to be legitimate or known to be fraudulent can be used to train each of the trees. Data overfitting can occur during the training process, however.

Overfitting results when a classifier essentially learns the sample data “too well.” This can mean that the classifier does not perform as well when presented with unknown data (e.g. a new electronic transaction that may or may not be fraudulent). As an example of overfitting, consider an image recognition classifier that is trained to identify pictures of cats. If the classifier suffers from overfitting, it may simple learn how to recognize the 2,500 individual cats that were used in its training data sample, but not really learn how to recognize cats more generally (or at least, not do this task as well as would be hoped).

One solution to avoid overfitting when using ensemble classifiers such as random forest and gradient boosting trees is to use tree dropout. One approach to tree dropout includes simply dropping a randomly selected percentage of trees from the classifier. If there are 1,000 decision trees and a random dropout of 5% is used, for example, the final classifier will include 950 decision trees, with 50 randomly selected trees being excluded.

This random dropout approach can be improved. This specification describes techniques to measure the performance of individual decision trees, and then to drop some of the worst performing trees, rather than simply dropping trees randomly. This can provide improved overall performance for a machine learning classifier.

Various examples are described below relative to electronic payment transactions, which may be particularly relevant to companies that facilitate such payments. The techniques of this disclosure can be broadly generalized, however, and used in any number of applications of ensemble based machine learning.

This specification includes references to “one embodiment,” “some embodiments,” or “an embodiment.” The appearances of these phrases do not necessarily refer to the same embodiment. Particular features, structures, or characteristics may be combined in any suitable manner consistent with this disclosure.

“First,” “Second,” etc. As used herein, these terms are used as labels for nouns that they precede, and do not necessarily imply any type of ordering (e.g., spatial, temporal, logical, cardinal, etc.).

Various components may be described or claimed as “configured to” perform a task or tasks. In such contexts, “configured to” is used to connote structure by indicating that the components include structure (e.g., stored logic) that performs the task or tasks during operation. As such, the component can be said to be configured to perform the task even when the component is not currently operational (e.g., is not on). Reciting that a component is “configured to” perform one or more tasks is expressly intended not to invoke 35 U.S.C. § 112(f) for that component.

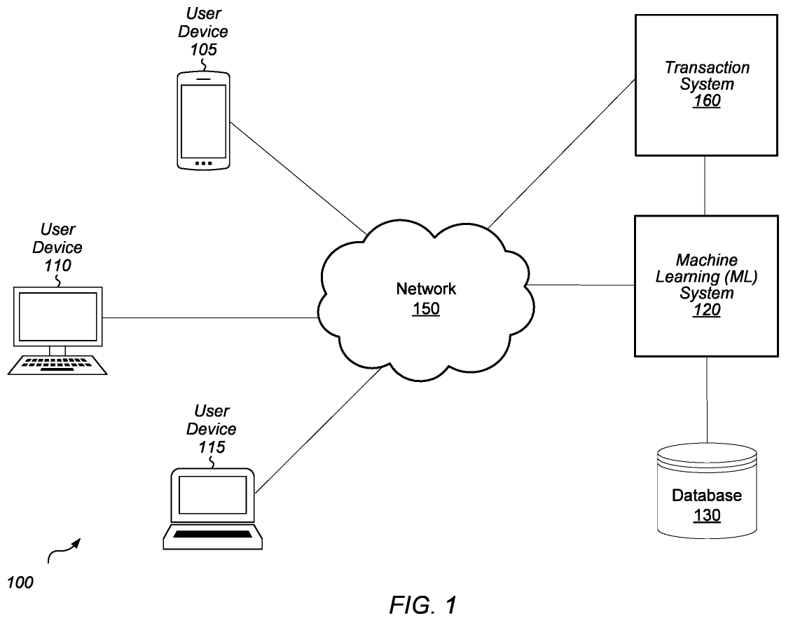

Turning to FIG. 1, a block diagram of a system 100 is shown. In this diagram, system 100 includes user devices 105, 110, 115, a machine learning system 120, a transaction system 160, and a network 150. Also depicted is database 130. Note that other permutations of this figure are contemplated (as with all figures). While certain connections are shown (e.g. data link connections) between different components, in various embodiments, additional connections and/or components may exist that are not depicted. Further, components may be combined with one other and/or separated into one or more systems.

User devices 105, 110, and 115 may be any type of computing device. Thus, these devices can be a smartphone, laptop computer, desktop computer, tablet computer, etc. As discussed below, user devices such as 105, 110, and 115 may engage in various actions, including transactions, using transaction system 160. Machine learning system 120 may comprise one or more computing devices each having a processor and a memory, as may transaction system 160. Network 150 may comprise all or a portion of the Internet. User devices 105, 110, and 115 may have particular characteristics that are used in determining whether to allow a particular electronic payment transaction, via machine learning models.

In various embodiments, machine learning (ML) system 120 can take operations related to creating, training, and/or operating a machine learning based program that can make predictions/decisions regarding data. ML system 120. Note that different aspects of operations described relative to machine learning system 120 (as well as other systems described herein) can be performed by two or more different computer systems in some embodiments. Techniques described relative to ML system 120 can be applied in a number of different contexts other than financial transaction risk assessment, although many examples below will be explained in relation to that concept.

Transaction system 160 may correspond to an electronic payment service such as that provided by PayPal™. Transaction system 160 may have a variety of associated user accounts allowing users to make payments electronically and to receive payments electronically. A user account may have a variety of associated funding mechanisms (e.g. a linked bank account, a credit card, etc.) and may also maintain a currency balance in the electronic payment account. A number of possible different funding sources can be used to provide a source of funds (credit, checking, balance, etc.). User devices 105, 110, and 115 can be used to access electronic payment accounts such as those provided by PayPal™. In various embodiments, quantities other than currency may be exchanged via transaction system 160, including but not limited to stocks, commodities, gift cards, incentive points (e.g. from airlines or hotels), etc.

Database 130 includes records related to various transactions taken by users of transaction system 160. These records can include any number of details, such as any information related to a transaction or to an action taken by a user on a web page or an application installed on a computing device (e.g., the PayPal app on a smartphone). Many or all of the records in records database 130 are transaction records including details of a user sending or receiving currency (or some other quantity, such as credit card award points, cryptocurrency, etc.). Data in database 130 may be used to train a machine learning classifier, in various embodiments. (And in some embodiments, data for machine learning tasks other than financial transaction risk assessment can be stored in database 130 and used to train a classifier.)

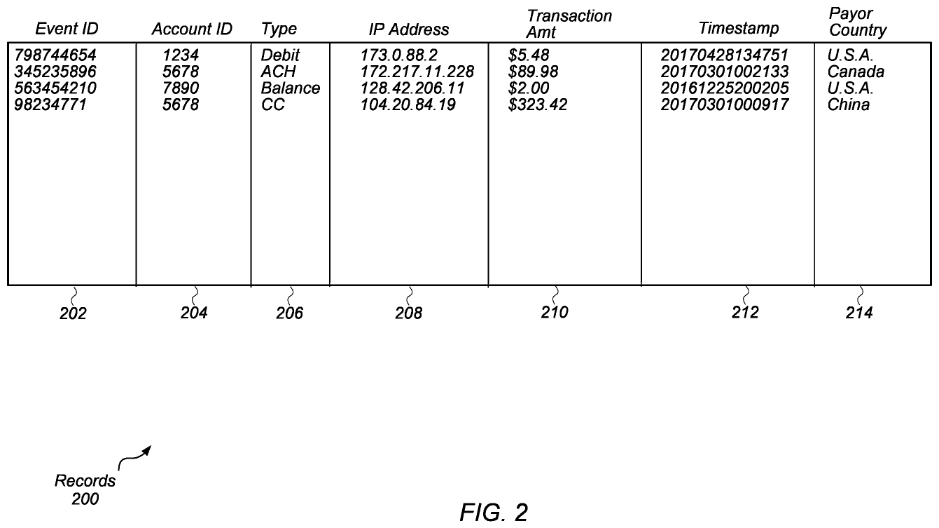

Turning to FIG. 2, a block diagram is shown of one embodiment of records 200. These records may be contained in database 130, for example (although database 130 may include many additional types of data as well). In this example, the records shown include various charges made by different funding mechanisms.

As shown, field 202 includes an event ID. This may be a globally unique event identifier within an enterprise associated with transaction system 160. Thus, in one embodiment, the event ID in field 202 includes a unique ID for each of millions of electronic payment transactions processed by a service provider such as PayPal™. Field 204 includes a unique account ID for a user.

Field 206 includes type of transaction. In this example, rows 1 and 4 are a credit card (“CC”) funded transaction, while row 2 is an Automated Clearinghouse (ACH) funded transaction. Row 3 is a balance funded transaction (e.g. a user had a pre-existing currency balance in her account that was used to pay another entity). Additional types of transactions and/or more specific information is also possible in various embodiments (e.g., different types of credit card networks could be specified, such as VISA™ or MASTERCARD™).

Fields 208 and 210 represent an IP address and a transaction amount (which may be specified in a particular currency such as US Dollars, Great Britain Pounds, etc.). The IP address might be the IP address of the user at the time the transaction was conducted, for example. Field 212 includes a transaction timestamp. In the examples shown, the timestamps are in the format (year) (two-digit month) (two-digit day) (hour) (minute) (seconds), but may be in any other format in various embodiments. Field 214 indicates a payor country—e.g. the residence country of the person who is sending funds to another entity.

Many additional pieces of information may be present in records database 130 in various embodiments. An email address associated with an account (e.g. which can be used to direct an electronic payment to a particular account using only that email address) can be listed. Home address, phone number, and any number of other personal details can be listed. Further, in various embodiments, databases may include event information on actions associated payment transaction, such as actions taken relative to a website, or relative to an application installed on a device such as the PayPal application on a smartphone. Database information can therefore include web pages visited (e.g., did a user travel to www.PayPal.com from www.eBay.com, or from some other domain?), order in which the pages were visited, navigation information, etc. Database information can include actions taken within an application on a smartphone such as the PayPal™ app. Database information can also include a location of where a user has logged into (authenticated) an account; unsuccessful login attempts (including IP address etc.); time of day and/or date of week for any event mentioned herein; funding sources added or removed and accompanying details (e.g. adding a bank account to allow currency to be added to or withdrawn from a user account), address or other account information changes, etc. In other words, a large variety of information can be obtained and used to determine the riskiness of a transaction (and this same information can be used to train a machine learning model that includes an ensemble classifier to assess risk).

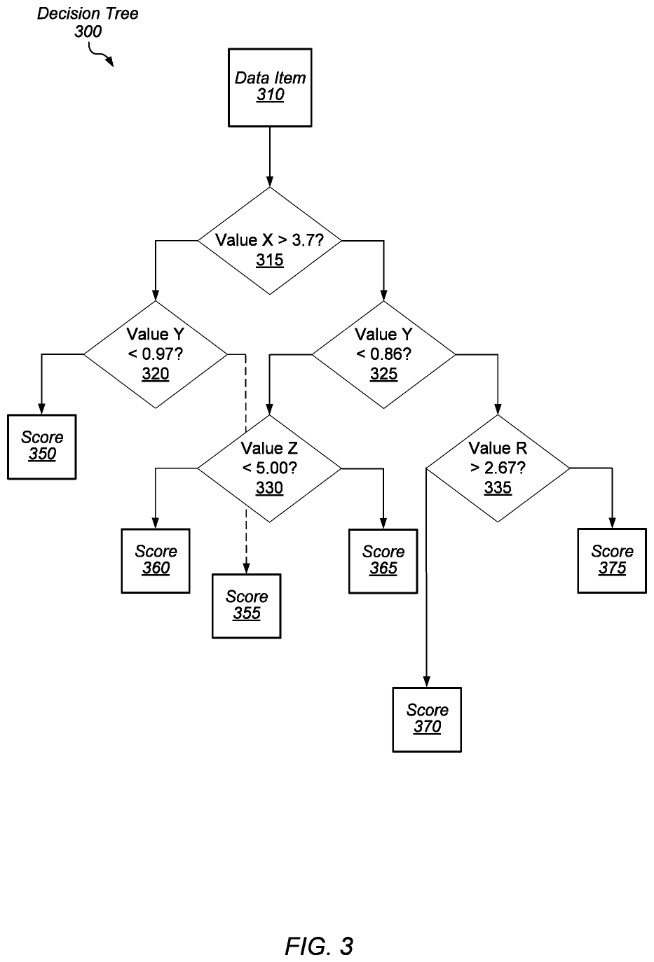

Turning to FIG. 3, a block diagram is shown of an example individual decision tree 300 relating to ensemble machine learning techniques. All aspects of this system may be implemented using computer software instructions, in various instances.

In this example, data item 310 is fed into the decision tree. Data item 310 can be any particular data having attribute values for various data attributes. The term “attribute value” is used variously herein to refer to an actual data value (e.g. true or false, numerical value, categorical value, etc.). The term “data attribute” is used variously to refer to the type of data. Thus, for an electronic payment transaction, a “data attribute” may be the amount of the transaction (e.g. in currency), and an “attribute value” could be $15.99.

At decision point 315, the attribute value for data attribute X is assessed. If the value of X is greater than 3.7, the decision tree will proceed to the right, otherwise it will proceed to the left (all such decision points in this example figure will operate in this manner—proceeding to the right if the condition is satisfied, otherwise proceeding to the left).

Proceeding left, the decision tree will assess the value of data attribute Y at decision point 320 (is the value for Y less than 0.97 for data item 310)? Depending on the value of Y, the decision tree will then terminate at score 350 or score 355 for data item 310.

The resulting score (e.g. score 350) for a data item can take a number of forms. In some cases, it will simply be a yes/no (true/false) decision—e.g., yes, this electronic transaction payment appears fraudulent, or no, this digital image does not appear to contain a picture of a cat. In other embodiments, the score may be a numeric assessment—e.g., on a 0 to 100 scale, where 100 represents a high or absolute certainty that a transaction is fraudulent and 0 represents a high or absolute certainty that a transaction is legitimate. Various scoring schemes for the output of a decision tree are possible. In many (if not all) cases, trees that are part of an ensemble machine learning classifier will all produce scores of the same format.

If the decision tree proceeds right from decision point 315, it will progress to decision point 325 where the value of data attribute Y will be assessed. Depending on this value, the decision tree will then progress to decision point 330 or 335, at which point a further evaluation will be made relative to data attributes Z and R respectively. The tree will then result in one of scores 360, 365, 370, or 375.

Different decision tree formats may be used in the techniques described below. Trees may vary in depth, number of data attributes assessed, etc. The tree shown in FIG. 3 features bipartite decision making (two choices on decision points) but tripartite or other formats are also possible.

As noted above, a trained classifier can include many different decision trees. These trees may examine different data attributes in different combinations and values to reach a final assessment (score). These resulting scores from different trees can then be combined (e.g. averaged, weighted average, or some other form) to produce a final result for an unknown data item. But not all of these trees may be equally useful-some may overperform, and some may underperform. The following figures include techniques for assessing the performance of individual trees, which can then be used to determine which trees can be dropped from the ensemble to provide better overall predictive performance.

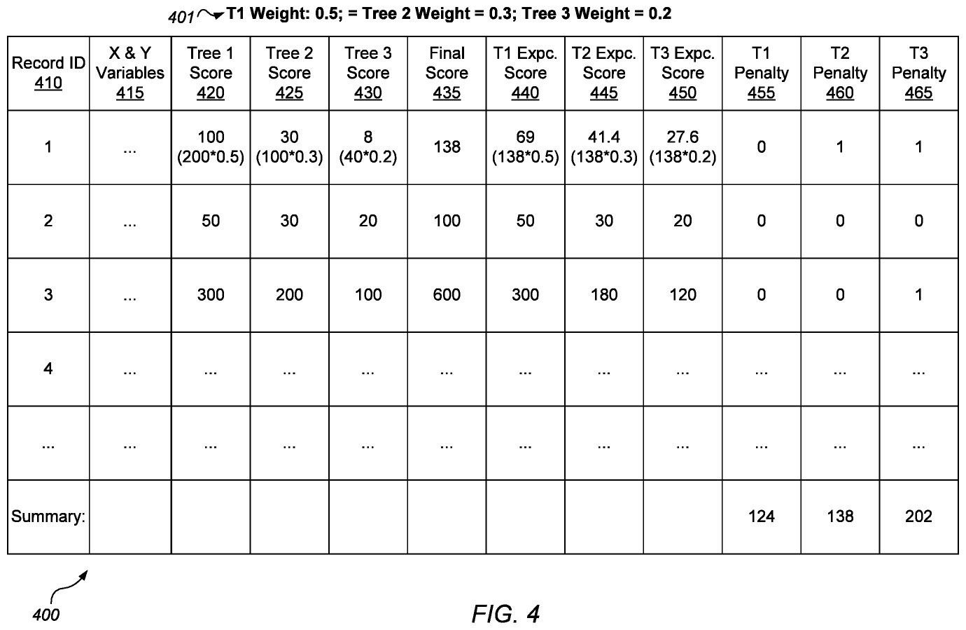

Turning to FIG. 4, a diagram of a table 400 is shown relating to evaluating performance of particular decision trees within a machine learning classifier, according to some embodiments. Techniques described can be generalized to larger numbers of decision trees, but for simplicity in this example, three different decision trees are evaluated.

This example assumes that a classifier has already been trained using first sample training data. A second set of data (e.g. validation data) is then used to score the decision trees. The training data and validation data can be allocated as desired, but in some embodiments, a mix of 70/30 may be used from an overall data set (e.g. 70% of the data for initial training, 30% for validation).

For each tree (three trees in this example), it will be evaluated against a particular data item in the validation set, represented by the rows of the table. Column 410 (Record ID) indicates the ID of each of these data items in the validation set. Only a few items are shown for ease of understanding, but there may be any number of items in the validation set (e.g. dozens, hundreds, thousands, or other). Likewise, there may be any number of decision trees as well, but only three are shown for ease of understanding. Column 415 may be used to hold X and Y variables (and in various embodiments, these columns may be actually separate in a table, but are shown in one column due to space constraints on the drawing page). In the case of electronic payment transactions, for examples, the X variables could be a few hundred pieces of data related to the transactions (transaction amount, etc., as discussed elsewhere). The Y variables (which may be a single variable) could be a classification of the particular data items—in the case of payment transactions, this could be a “zero” indicating the transaction is labeled as not being fraudulent, or “one” indicating that the transaction is labeled as fraud.

Columns 420, 425, and 430 show the respective scores for decision trees Tree 1, Tree 2, and Tree 3 for each of the data items in their respective rows. The trees in this example also each have different weights (0.5 for Tree 1, 0.3 for Tree 2, 0.2 for Tree 3). Total weights do not have to add up to 1.0, however.

For row 1, Tree 1 has a score of 100, Tree 2 has a score of 30, and Tree 3 has a score of 8 (based on raw scores of 200, 100, and 40, which are then scaled appropriately based on the tree weight). Assume in this example that the data item being scored in row 1 is an electronic transaction that is labeled as being fraudulent. In this example, the scores for the trees represent those trees assessments of whether or not the transaction is fraudulent, with a higher number indicating a higher likelihood of fraud.

Column 435 shows the final score of the ensemble (adding the scores from the three trees). Columns 440, 445, and 450 show the expected score for each of the three trees, which is based on the actual scores for those trees and each of those trees respective weightings. (More particularly, the formula for expected score can be calculated as actual score*weight for that tree/total weight for all trees.)

After calculating the expected scores for the trees, an assessment of each tree's performance can be made, which can include assessing a penalty on underperforming trees. For row 1, Tree 1 overperformed (actual score 100, expected score 69). No penalty is assessed on Tree 1. Trees 2 and 3 both underperformed, however, and so each of those trees receives a penalty in this example. The penalty in this case is assessed as either 1 or 0 (binary penalty). Thus, in some instances when a penalty is assessed, the penalty is the same regardless of a degree to which a penalized decision tree underperformed an expected performance score—missing the expected score slightly may be penalized the same (for a particular data item in a validation set) as missing the expected score by a larger amount. However, other schemes are possible as will be discussed below.

In the example of row 2, all trees performed as expected and none is assessed a penalty. In row 3, Trees 1 and 2 overperformed and got no penalty, but Tree 3 underperformed and received a penalty.

Many more additional data items in the validation set can then be tested against tree performance. In the final row, a total for the penalties for each tree is shown. In this case, Tree 1 received 124 penalty marks, Tree 2 received 138, and Tree 3 received 202. Based on this validation data set, Tree 3 would be considered the worst performing overall tree. As the worst tree, it could then be dropped from the classifier, leaving only Tree 1 and Tree 2. In actual practice, of course, many more trees would likely be used, but this approach can be applied to larger sized ensemble classifiers as well, and more than one tree can be dropped from the ensemble based on performance.

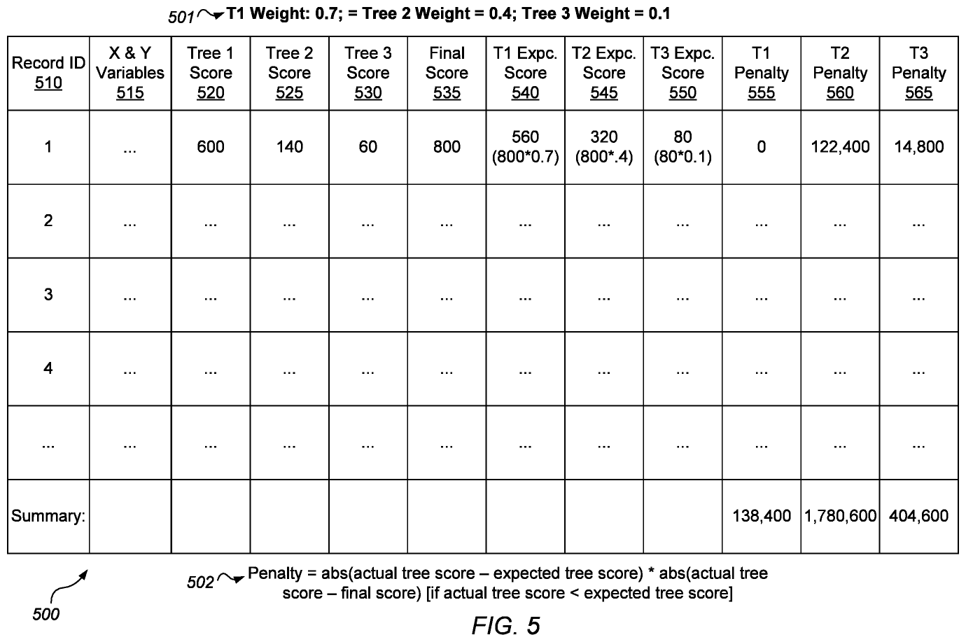

Turning to FIG. 5, a diagram of another table 500 is shown relating to evaluating performance of particular decision trees within a machine learning classifier, according to some embodiments. Again, techniques described here can be generalized to larger numbers of decision trees, but for simplicity in this example, three different decision trees are evaluated. This example is similar to that of FIG. 4, but uses an alternate method for evaluation tree performance (e.g. calculating a penalty for underperforming trees).

Table 500 includes columns 510, 515, 520, 525, 530, 535, 540, 545, 550, 555, 560, and 565. These columns may function similarly to respective columns shown in FIG. 4. The weighting of Trees 1, 2, and 3 is respectively 0.7, 0.4, and 0.1 in this example. The final score in column 535 and expected scores in columns 540, 545, and 550 are calculated similarly as described above relative to FIG. 4. Calculating the penalties (e.g. performance of the individual decision trees) is performed differently in this example, however.

In this example, Tree 1 has no penalty score for row 1 (in column 555) as its performance exceeded expectation. Both Tree 2 and Tree 3, however, underperformed their expected scores. The method of penalty calculation here causes a larger numeric penalty to be assigned the worse a tree has performed.

There are many different ways of assessing a larger penalty for worse performing trees. In this particular example, the formula used is

Penalty=abs(actual tree score−expected tree score)*abs(actual tree score−final score)

This penalty may only be invoked if the tree underperforms (e.g. if actual tree score is less than the expected tree score. The “abs” operator is the absolute value (negative numbers are turned into a positive before multiplying).

Using this methodology, it can be seen that while Tree 3 did not perform as well as expected. Tree 2 performed even worse. Tree 3 achieved 75% of its expected value (60 instead of 80), but Tree 2 did not even achieve 50% of its expected value (140 instead of 320). The numeric penalties seen in columns 560 and 565 reflect the underperforming evaluation on the first data item in the validation data set. The particular formula used here amplifies the penalty the farther below the expected score that a tree actually delivers. Thus, a tree that is 400/% below its expected value, for example, will typically be penalized more than twice as much as a tree that that is only 20% below its expected value (e.g. the penalty structure functions non-linearly).

Many different evaluation schemes are possible when looking at individual tree performance against a validation data set to see which are the worst performing trees in a classifier. Linear methods may be used (e.g. each tree gets a penalty score proportionate to its underperformance) as well as non-linear methods (e.g. where worse performing trees may be penalized increasingly harshly for underperforming).

Thus, in the case of linear penalty schemes, a numeric penalty can be assigned to a particular decision tree that is proportionate to a percentage for which that particular decision tree underperformed its expected score for a given one data item (e.g. if that tree underperforms by 15% for a particular data item in the validation set it might get a penalty score of 50, and if it underperforms by 30% for another particular data item in the validation set it would get a proportionate penalty score of 100).

In the case of non-linear penalty schemes, a numeric penalty can be assigned to a particular decision tree that is proportionately larger based on a percentage for which that particular decision tree underperformed its expected score for a given one of the plurality of second data items. Thus, if a tree underperforms by 10% for a particular data item in the validation set it might get a penalty score (e.g. 500) that is more than twice as large as if it underperformed by 5% for another particular data item in the validation set (e.g. 125). As stated above, penalties can get progressively larger the worse a tree performs on a particular validation data item. Penalty scores can also be tiered (e.g. underperforming by less than 5% for a given data item in the validation data set is a penalty score of 25, underperforming by 5% or more but less than 10% is a penalty score of 100, etc.). As will be appreciated, many different performance scoring schemes are possible.

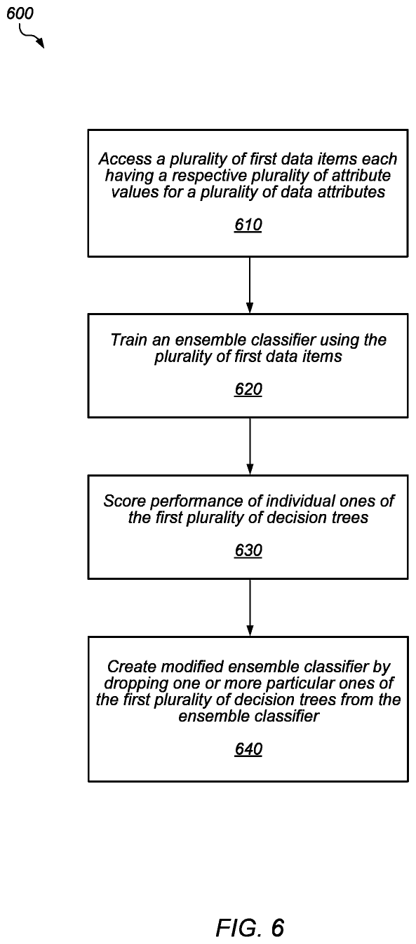

Turning to FIG. 6, a flowchart is shown of a method 600 relating to creating an improved machine learning classifier by evaluating individual decision trees in an ensemble classifier, according to some embodiments. Operations described relative to FIG. 6 may be performed, in various embodiments, by any suitable computer system and/or combination of computer systems, including ML system 120.

For convenience and ease of explanation, operations described below will simply be discussed relative to ML system 120 rather than any other system, however. Further, various elements of operations discussed below may be modified, omitted, and/or used in a different manner or different order than that indicated. Thus, in some embodiments, ML system 120 may perform one or more operations while another system might perform one or more other operations.

In operation 610, ML system 120 accesses a plurality of first data items each having a respective plurality of attribute values for a plurality of data attributes, according to some embodiments.

These data items can be for electronic payment transactions. The data attributes for the transactions can include a variety of different types of data (as noted above), such as transaction amount, date of transaction, time of transaction, currency of transaction (Japanese Yen, Australian Dollar, British Pound, etc.), website address where item was purchased (if applicable) such as eBay.com™, etsy.com™, etc., shipping address for order, billing address of buyer, device information for the payor, etc. There may be hundreds or thousands of different data attributes (or more, or less). Each of the plurality of first data items can have attribute values for some or all of these data attributes.

Many different other types of data items can be used, however, not just electronic payment transactions. Note that not all data in the plurality of first data items has to have an identical feature set—that is, one data item might have attribute values for attributes 1, 2, 5, and 6, (with attributes 3, 4, and 7 being unspecified) while another data item might have attribute values for attributes 1, 3, 4, and 7 (with attributes 2, 5, and 6 being unspecified).

In operation 620, ML system 120 trains an ensemble classifier using the plurality of first data items from operation 610, according to some embodiments. The ensemble classifier may include a first plurality of decision trees, and be configured to produce an output for a given data item having attribute values for the plurality of data attributes.

The ensemble classifier can be a machine learning classifier that is based on a number of different individual classifiers (e.g. decision trees), and can include a random forest classifier or a gradient boosting tree classifier, in various embodiments. Other types of ensemble classifiers may be used in other embodiments. When training an ensemble classifier that includes different decision trees, each of those decision trees may be adjusted based on an initial set of data (i.e. training data) to optimize outcomes. The trees in an ensemble classifier can be adjusted according to various parameters (depth of tree, number of variables in each tree, etc.).

The trained ensemble classifier can produce an output for a given data item having attributes values for a plurality of data attributes. In other words, for any given electronic payment transaction, the classifier might produce a number score between 0 and 100 (with 0 indicating the transaction isn't fraudulent and 100 indicating that it is, for example). Other scoring schemes are possible, of course.

In operation 630, ML system 120 scores performance of individual ones of the first plurality of decision trees, according to some embodiments. This scoring may be done using a plurality of second data items each having a respective plurality of attribute values for the plurality of data attributes. Thus, while a classifier may be trained (e.g. originally created) using a batch of training data, a different batch of validation data (the second data items) may be used to test performance of trees within the classifier.

Performance scoring of individual trees may be done according to the techniques of FIG. 4 and FIG. 5, in various embodiments. All or a portion of the individual trees in an ensemble classifier can be scored relative to other data items to see how well they perform relative to expectations.

In operation 640, based on the scored performance in operation 630, ML system 120 creates a modified ensemble classifier by dropping one or more particular ones of the first plurality of decision trees from the ensemble classifier, according to some embodiments. In various cases, the worst performing trees will be dropped. The bottom 1%, 3%, 5%, or some other number of trees can be removed from a classifier to create a modified classifier. In one embodiment, at least one of the dropped trees is in the worst performing 20% of a first plurality of decision trees in an ensemble classifier.

Other dropping schemes are possible as well. A random selection of a portion of the lowest performing trees could be dropped, for example (e.g., randomly dropping 40% of the worst 6% of the trees). In some embodiments, any decision tree can even be dropped from the classifier based on any scoring criteria as desired—in other words, a scheme can specify that any particular trees are dropped based on any criteria (e.g. drop the bottom 1%, then randomly drop half of the next bottom 2%, etc.). Thus, in some cases, not all of the worst X % performing trees are necessarily dropped—it may be the case that some of these trees are dropped but not all of them are dropped. Higher performing trees can even be dropped if desired.

### Computer-Readable Medium

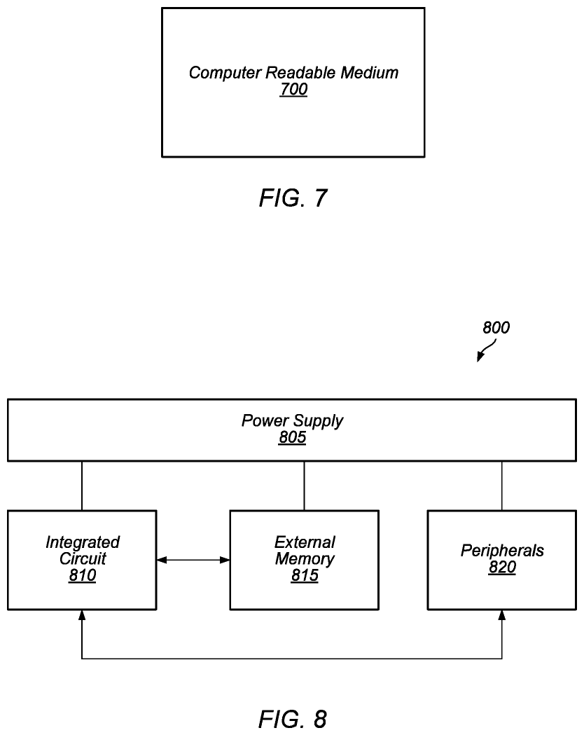

Turning to FIG. 7, a block diagram of one embodiment of a computer-readable medium 700 is shown. This computer-readable medium may store instructions corresponding to the operations of FIG. 6 and/or any techniques described herein. Thus, in one embodiment, instructions corresponding to machine learning system 120 may be stored on computer-readable medium 700.

Note that more generally, program instructions may be stored on a non-volatile medium such as a hard disk or FLASH drive, or may be stored in any other volatile or non-volatile memory medium or device as is well known, such as a ROM or RAM, or provided on any media capable of staring program code, such as a compact disk (CD) medium, DVD medium, holographic storage, networked storage, etc. Additionally, program code, or portions thereof, may be transmitted and downloaded from a software source, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing aspects of the present invention can be implemented in any programming language that can be executed on a server or server system such as, for example, in C, C+, HTML, Java, JavaScript, or any other scripting language, such as VBScript. Note that as used herein, the term “computer-readable medium” refers to a non-transitory computer readable medium.

### Computer System

In FIG. 8, one embodiment of a computer system 800 is illustrated. Various embodiments of this system may be machine learning system 120, transaction system 160, or any other computer system as discussed above and herein.

In the illustrated embodiment, system 800 includes at least one instance of an integrated circuit (processor) 810 coupled to an external memory 815. The external memory 815 may form a main memory subsystem in one embodiment. The integrated circuit 810 is coupled to one or more peripherals 820 and the external memory 815. A power supply 805 is also provided which supplies one or more supply voltages to the integrated circuit 810 as well as one or more supply voltages to the memory 815 and/or the peripherals 820. In some embodiments, more than one instance of the integrated circuit 810 may be included (and more than one external memory 815 may be included as well).

The memory 815 may be any type of memory, such as dynamic random access memory (DRAM), synchronous DRAM (SDRAM), double data rate (DDR, DDR2, DDR6, etc.) SDRAM (including mobile versions of the SDRAMs such as mDDR6, etc., and/or low power versions of the SDRAMs such as LPDDR2, etc.), RAMBUS DRAM (RDRAM), static RAM (SRAM), etc. One or more memory devices may be coupled onto a circuit board to form memory modules such as single inline memory modules (SIMMs), dual inline memory modules (DIMMs), etc. Alternatively, the devices may be mounted with an integrated circuit 810 in a chip-on-chip configuration, a package-on-package configuration, or a multi-chip module configuration.

The peripherals 820 may include any desired circuitry, depending on the type of system 800. For example, in one embodiment, the system 800 may be a mobile device (e.g. personal digital assistant (PDA), smart phone, etc.) and the peripherals 820 may include devices for various types of wireless communication, such as Wi-Fi, Bluetooth, cellular, global positioning system, etc. Peripherals 820 may include one or more network access cards. The peripherals 820 may also include additional storage, including RAM storage, solid state storage, or disk storage. The peripherals 820 may include user interface devices such as a display screen, including touch display screens or multitouch display screens, keyboard or other input devices, microphones, speakers, etc. In other embodiments, the system 800 may be any type of computing system (e.g. desktop personal computer, server, laptop, workstation, net top etc.). Peripherals 820 may thus include any networking or communication devices necessary to interface two computer systems.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed by various described embodiments. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method, comprising:
accessing a plurality of first data items each having a respective plurality of attribute values for a plurality of data attributes;
training an ensemble classifier using the plurality of first data items, the ensemble classifier comprising a first plurality of decision trees, wherein the ensemble classifier is configured to produce an output for a given data item having attribute values for the plurality of data attributes;
scoring performance of individual ones of the first plurality of decision trees, the scoring done using a plurality of second data items each having a respective plurality of attribute values for the plurality of data attributes; and
based on the scored performance, a computer system creating a modified ensemble classifier by dropping one or more particular ones of the first plurality of decision trees from the ensemble classifier.

2. The method of claim 1, wherein scoring performance of individual ones of the first plurality of decision trees comprises, for each of the individual trees scored:
assessing a penalty to that decision tree if that decision tree underperformed an expected performance score for a given one of the plurality of second data items; and
not assessing a penalty to that decision tree if that decision tree met the expected performance score for the given one of the plurality of second data items.

3. The method of claim 1, wherein dropping the one or more particular ones of the first plurality of decision trees is based on those trees having a lower expected contribution than others of the first plurality of decision trees.

4. The method of claim 1, wherein dropping the one or more particular ones of the first plurality of decision trees is based on those trees having a lower expected contribution than a particular percentage of all others of the first plurality of decision trees.

5. The method of claim 1, wherein the ensemble classifier comprises a random forest classifier.

6. The method of claim 1, wherein the ensemble classifier comprises a gradient boosting tree classifier.

7. The method of claim 1, wherein the plurality of first data items and the plurality of second data items comprise electronic payment transactions.

8. The method of claim 7, further comprising:
receiving a particular electronic payment transaction request;
using the modified ensemble classifier, determining a fraud risk score corresponding to the particular electronic payment transaction request; and
based on the fraud risk score, determining whether to allow the particular electronic payment transaction request.

9. The method of claim 1, wherein scoring the performance of the individual ones of the first plurality of decision trees comprises scoring all of the first plurality of decision trees.

10. A system, comprising:
a processor; and
a memory having stored thereon instructions that are executable by the processor to cause the system to perform operations comprising:
accessing a plurality of first data items each having a respective plurality of attribute values for a plurality of data attributes;
training an ensemble classifier using the plurality of first data items, the ensemble classifier comprising a first plurality of decision trees, wherein the ensemble classifier is configured to produce an output for a given data item having attribute values for the plurality of data attributes;
scoring performance of individual ones of the first plurality of decision trees, the scoring done using a plurality of second data items each having a respective plurality of attribute values for the plurality of data attributes; and
based on the scored performance, creating a modified ensemble classifier by dropping one or more particular ones of the first plurality of decision trees from the ensemble classifier, wherein at least one of the dropped decision trees is in the worst performing 20% of the first plurality of decision trees.

11. The system of claim 10, wherein scoring performance of individual ones of the first plurality of decision trees comprises scoring performance of each of the first plurality of decision trees.

12. The system of claim 10, wherein scoring performance of individual ones of the first plurality of decision trees comprises, for each of the individual trees scored:
for each of the plurality of second data items:
assessing a penalty to that decision tree for that second data item if that decision tree underperformed an expected performance score for that second data item; and
not assessing a penalty to that decision tree for that second data item if that decision tree met the expected performance score for that second data item.

13. The system of claim 12, wherein the operations further comprising totaling net penalties for each of the first plurality of decision trees and dropping one or more of the worst performing decision trees based on the net penalties.

14. The system of claim 12, wherein the penalty is the same regardless of a degree to which a penalized decision tree underperformed the expected performance score.

15. A non-transitory computer-readable medium having stored thereon instructions that are executable by a computer system to cause the computer system to perform operations comprising:
scoring performance of individual ones of a first plurality of decision trees of an ensemble classifier, wherein the ensemble classifier was created using a training process with a plurality of first data items each having a respective plurality of attribute values for a plurality of data attributes, wherein the ensemble classifier is configured to produce an output for a given data item having attribute values for the plurality of data attributes, the scoring done using a plurality of second data items each having a respective plurality of attribute values for the plurality of data attributes; and
based on the scored performance, creating a modified ensemble classifier by dropping one or more particular ones of the first plurality of decision trees from the ensemble classifier.

16. The non-transitory computer-readable medium of claim 15, wherein scoring performance of individual ones of the first plurality of decision trees comprises:
assigning a numeric penalty to a particular one of the first plurality of decision trees that is proportionate to a percentage for which that particular decision tree underperformed its expected score for a given one of the plurality of second data items.

17. The non-transitory computer-readable medium of claim 15, wherein scoring performance of individual ones of the first plurality of decision trees comprises:
assigning a numeric penalty to a particular one of the first plurality of decision trees that is proportionately larger based on a percentage for which that particular decision tree underperformed its expected score for a given one of the plurality of second data items.

18. The non-transitory computer-readable medium of claim 15, wherein a particular one of the plurality of first data items has a first attribute value for a first one of the plurality of data attributes but another one of the plurality of first data items does not have a specified attribute value for the first one of the plurality of data attributes.

19. The non-transitory computer-readable medium of claim 15, wherein the plurality of first data items and the plurality of second data items comprise electronic payment transactions.

20. The non-transitory computer-readable medium of claim 15, wherein the operations further comprise:
receiving a particular electronic payment transaction request;
using the modified ensemble classifier, determining a fraud risk score corresponding to the particular electronic payment transaction request; and
based on the fraud risk score, determining whether to allow the particular electronic payment transaction request.
